(19) United States
(12) Patent Application Publication
(10) Pub. No.: US 2008/0047789 A1
(43) Pub. Date: Feb. 28, 2008

(54) Motor-driven parking brake apparatus

(76) Inventor: Kaoru Tsubouchi, Toyota-shi (JP)

Correspondence Address: BUCHANAN, INGERSOLL & ROONEY PC, POST OFFICE BOX 1404, ALEXANDRIA, VA, 22313-1404, US

(21) Appl. No.: 11/889,619

(22) Filed: Aug. 15, 2007

(30) Foreign Application Priority Data
Aug. 24, 2006 (JP) 2006-227469

(51) Int. Cl. B60T 17/00

(52) U.S. Cl. 188/156

(57) ABSTRACT

The housing of a motor-driven parking brake apparatus includes a pair of cable reaction-receiving portions for receiving reactions from cables generated due to tensions of the cables, and an axial load-receiving portion for receiving axial load from a screw shaft generated due to the tensions of the cables. These portions, which must be formed to have a large wall thickness, are provided on one side of the housing. This structure reduces the size of the housing. In addition, the axial load-receiving portion is provided between the paired cable reaction-receiving portions. This arrangement further reduces the size of the housing.

### CROSS REFERENCE TO RELATED APPLICATION

This application is based on and claims under 35 U.S.C. sect, 119 with respect to Japanese Patent Application No. 2006-227469 filed on Aug. 24, 2006, the entire content of which is incorporated herein by reference.

### BACKGROUND OF THE INVENTION

1. Field of the Invention

The present invention relates to a motor-driven parking brake apparatus, and is applicable to, for example, a parking brake apparatus for a vehicle.

2. Description of the Related Art

Japanese Patent Application Laid-Open (kokal) No. 2006-17158 discloses a motor-driven parking brake apparatus which includes a housing; an electric motor fixed to the housing; a shaft member which rotates about its axis upon receipt of rotational drive torque of the motor through one end of the shaft member; a conversion mechanism which converts rotational motion of the shaft member to translational motion of a translational movement portion; a pair of cables having first ends connected to the translational movement portion; and a pair of parking brakes connected to second ends of the cables. The housing includes a pair of reaction-receiving portions for receiving reactions from the cables generated due to tensions of the cables, and an axial load-receiving portion for receiving axial load from the other end of the shaft member, the load being generated due to the tensions of the cables.

In the motor-driven parking brake apparatus, one of the reaction-receiving portions is provided on a first side of the housing and the other reaction-receiving portion is provided on the opposite second side, and the reactions from the cables act on the respective sides. Since the axial load-receiving portion is also provided on the first side, the axial load from the other end of the shaft member acts on the first side of the housing. Therefore, in order to secure the strength of the housing, both the first and second sides of the housing must be formed to have a large wall thickness, and a bottom portion and side walls, which connect the first and second sides of the housing, must be formed to have a large wall thickness. Therefore, the conventional motor-driven parking brake apparatus has a problem in that downsizing of the housing is difficult.

### SUMMARY OF THE INVENTION

The present invention has been accomplished in order to solve the above-described problem, and an object of the present invention is to provide a motor-driven parking brake apparatus whose housing can be downsized.

The present invention is applied to a motor-driven parking brake apparatus of the above-described type and is characterized in that the pair of reaction-receiving portions and the axial load-receiving portion are provided on one side of the housing, and the axial load-receiving portion is provided between the pair of reaction-receiving portions.

According to this structure, the pair of reaction-receiving portions and axial load-receiving portion (three portions) of the housing, which must have a large wall thickness, can be disposed together on one side of the housing. Consequently, the remaining portion of the housing is not required to have a high strength or large wall thickness, so that the housing can be downsized. In addition, the axial load-receiving portion is provided between the pair of reaction-receiving portions. This structure enables the shaft member to be disposed between the pair of cables, to thereby further downsize the housing.

In this case, preferably, a load sensor for detecting axial load of the shaft member is provided between the axial load-receiving portion of the housing and the other end of the shaft member. The load sensor may be a pressure sensor which detects pressure generated due to the axial load of the shaft member or a displacement sensor which detects displacement of a movable member which moves in accordance with the axial load of the shaft member. The axial load of the shaft member is proportional to cable tension. Accordingly, control of the cable tension (i.e., control of the electric motor) can be performed on the basis of the axial load of the shaft member detected by means of the load sensor.

The above-described structure enables a space formed within the housing between the cables to be effectively used as a space for disposing the load sensor. Accordingly, an increase in the size of the housing due to provision of the load sensor within the housing can be suppressed.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a partial cutaway plan view showing a motor-driven parking brake apparatus according to a first embodiment of the present invention;

FIG. 2 is an enlarged view of the pressure sensor shown in FIG. 1;

FIG. 3 is a diagram used for explaining operation of the pressure sensor shown in FIG. 1; and

FIG. 4 is an enlarged view of a displacement sensor provided in a motor-driven parking brake apparatus according to a second embodiment of the present invention.

### DESCRIPTION OF THE PREFERRED EMBODIMENTS

Embodiments of the present invention will be described with reference to the drawings.

### First Embodiment

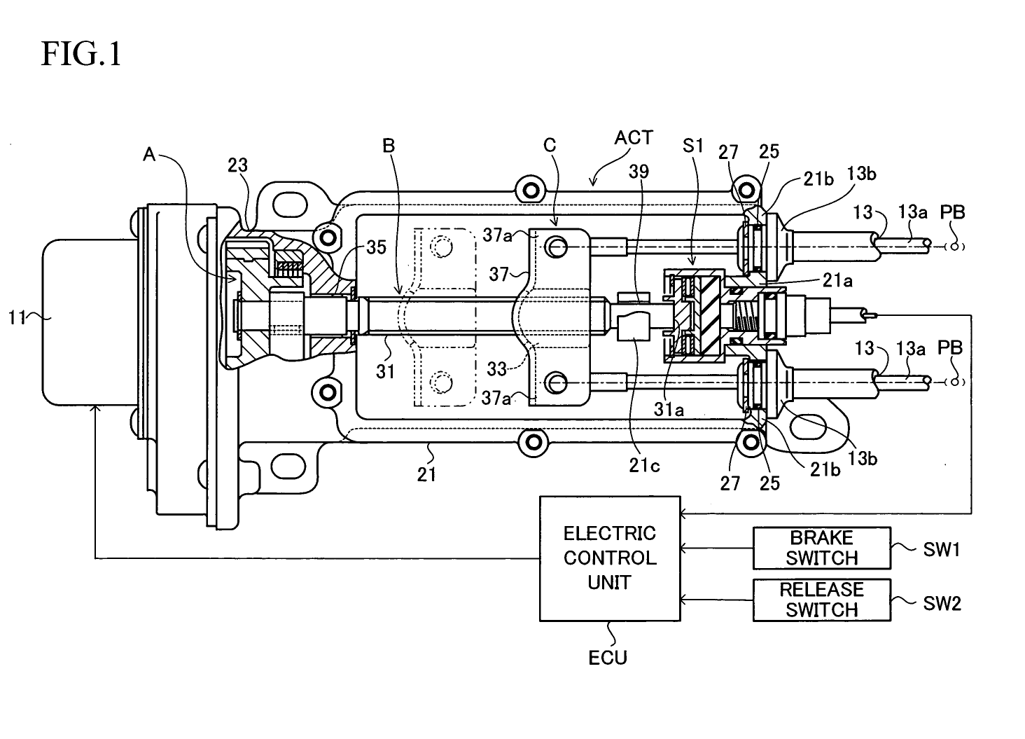

FIG. 1 shows a motor-driven parking brake apparatus for an automobile according to a first embodiment of the present invention. This motor-driven parking brake apparatus includes an actuator section ACT, a pair of parking brakes PB driven by the actuator section ACT, and an electric control unit ECU which controls the actuator section ACT. The actuator section ACT includes a speed reduction mechanism A for transmitting rotational drive torque of an electric motor 11, while reducing the rotational speed; a conversion mechanism B for converting rotational motion, transmitted by the speed reduction mechanism A, into translational motion; an equalizer mechanism C which distributes force produced by the translational motion to two output portions; a pair of cables 13 whose first ends are connected to the corresponding output portions of the equalizer mechanism C and whose second ends are connected to the corresponding parking brakes PB; and a pressure sensor S1 (load sensor) which detects pressure generated due to axial load of a screw shaft 31 (shaft member) to be described later, the axial load being proportional to tension of the pair of cables 13 (cable tension).

Operation of the electric motor 11 is controlled by means of the electric control apparatus ECU on the basis of signals from a brake switch SW1, a release switch SW2, and the pressure sensor S1.

The speed reduction mechanism A is composed of an unillustrated multi-stage train of reduction gears, which are assembled in a casing 23 attached to a housing 21. The speed reduction mechanism A transmits rotational drive torque of the electric motor 11 to a first end of the screw shaft 31, while reducing the rotational speed.

The conversion mechanism B includes the above-mentioned screw shaft 31, and a nut 33 in screw engagement with the screw shaft 31. The screw shaft 31 is assembled to the housing 21 such that the screw shaft 31 is rotatable and axially movable, via a bearing 35 provided at the first end of the screw shaft 31, a bearing 39 accommodated in a support 21c fixed to the housing 21 at a second end of the screw shaft 31, and the above-described pressure sensor S1, which functions as a thrust bearing, provided at the second end of the screw shaft 31, and assembled to an axial load-receiving portion 21a of the housing 21. By virtue of the above-described configuration, the screw shaft 31 rotates about its axis upon receipt of the rotational drive torque of the electric motor 11 through the first end of the screw shaft 31, and axial load of the screw shaft 31 is transmitted to the pressure sensor S1. When the screw shaft 31 is driven to rotate in the regular direction, the nut 33 is moved (effects translational motion) along the axial direction of the screw shaft 31 from a release position indicated by a solid line in FIG. 1 to a braking position indicated by a two-dot chain line in FIG. 1. When the screw shaft 31 is driven to rotate in the reverse direction, the nut 33 is moved along the axial direction of the screw shaft 31 toward the release position indicated by the solid line in FIG. 1.

The equalizer mechanism C equally distributes the force generated as a result of the translational motion and acting on the nut 33 to the two output portions, and is composed of a lever 37 attached to the nut 33. The lever 37 is assembled, at its central portion, to the nut 33 so as to be swingable by a predetermined amount. End portions of inner wires 13a of the cables 13 are rotatably connected to a pair of arms 37a, which are the two output portions. First ends 13b of outer tubes of the cables 13 are fixedly inserted into circular mount holes of a pair of cable reaction-receiving portions 21b of the housing 21 via O-rings 25, and are prevented from coming off the holes by means of clips 27. The nut 33 and the lever 37 constitute a translational movement portion.

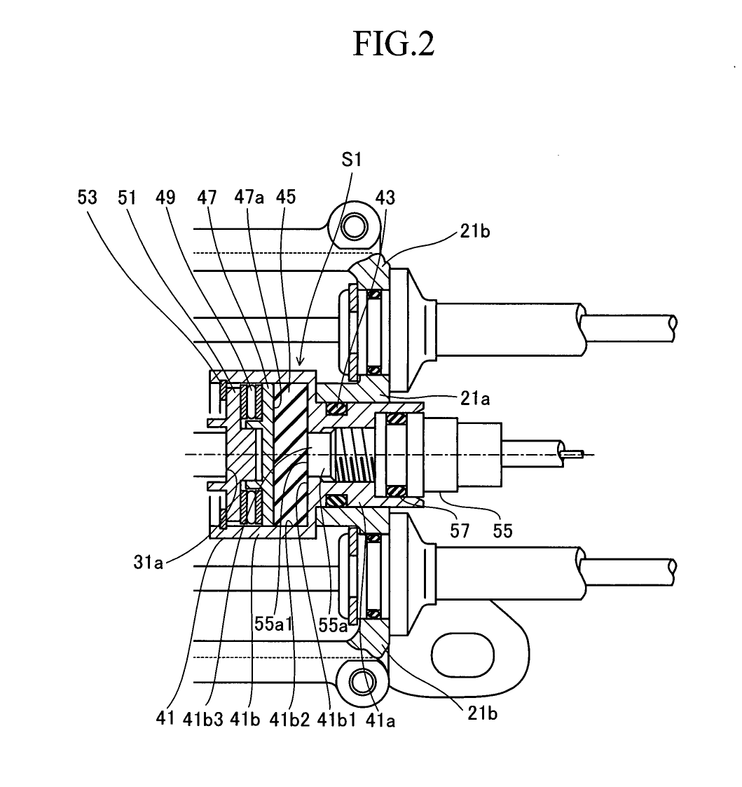

As shown in FIG. 2, which is an enlarged view of the pressure sensor S1, the pressure sensor S1 includes a casing 41, which assumes the form of a stepped cylindrical tube, and has a generally cylindrical base portion 41a (smaller diameter portion), and a cylindrical cup portion 41b (larger diameter portion) integral with the base portion 41a.

The base portion 41a is inserted into and fixed to a circular mount hole of the axial load-receiving portion 21a of the housing 21 via an O-ring 43 to be coaxial with the screw shaft 31. Notably, the base portion 41a is fixed to the housing 21 by means of an unillustrated screw embedded in the axial load-receiving portion 21a such that the base portion 41a is immobilized in the rotational and axial directions. The cylindrical cup portion 41b is fixed to the housing 21 so that the cylindrical cup portion 41b is disposed within the housing 21 coaxially with the screw shaft 31 and is opened toward the second end 31a of the screw shaft 31.

A disk-shaped transmission member 45 (elastic member) formed of an elastomer material such as rubber is accommodated in the interior space of the cylindrical cup portion 41b coaxially with the screw shaft 31 so that the transmission member 45 comes in close contact with a bottom surface (flat surface) of a bottom portion 41b1 of the cylindrical cup portion 41b and an inner cylindrical surface 41b2 of the cylindrical cup portion 41b. A disk-shaped plate 47, a bearing 49, and a disk-shaped plate 51 are disposed between the transmission member 45 and the second end 31a of the screw shaft 31 in such a manner that these members are axially stacked in this sequence as viewed from the side toward the transmission member 45 and are coaxial with the screw shaft 31. A surface of the plate 51 facing the screw shaft 31 is always in contact with the second end 31a of the screw shaft 31. The plate 47 (along with the bearing 49 and the plate 51) is held by means of a clip 53 fixed to the cylindrical cup portion 41b, so that the plate 47 is prevented from coming out of the interior space of the cylindrical cup portion 41b.

The plate 47, the bearing 49, and the plate 51 can axially move within the interior space of the cylindrical cup portion 41b. By virtue of this structure, the transmission member 45 receives all the axial load of the screw shaft 31 (hereinafter referred to as “total load”) from a circular surface 47a of the plate 47 via the plate 51, the bearing 49, and the plate 47, where the circular surface 47a is in close contact with the transmission member 45; and the casing 41 (the bottom portion 41b1 of the cylindrical cup portion 41b thereof) receives the axial load of the screw shaft 31 via the transmission member 45.

The bearing 49 permits relative rotation between the plate 47 and the plate 51 about the axis. Thus, when the screw shaft 31 rotates, the plate 51 smoothly rotates together with the screw shaft 31, but the plate 47 and the transmission member 45 do not rotate. Since the bearing 49 reduces frictional torque which the second end 31a of the screw shaft 31 receives due to rotation of the screw shaft 31, a drop in drive efficiency of the electric motor 11 stemming from the frictional torque can be reduced.

A circular opening 41b3 is formed in the bottom portion 41b1 of the cylindrical cup portion 41b coaxially with the screw shaft 31 so as to connect the interior space of the cylindrical cup portion 41b and that of the base portion 41a . Thus, a circular portion of the transmission member 45 corresponding to the circular opening 41b3 (hereinafter referred to as “exposed portion”) is exposed to the interior space of the base portion 41a .

A known pressure detection element 55 is screwed into the interior space of the base portion 41a coaxially with the screw shaft 31 via an O-ring 57. A cylindrical columnar end portion 55a of the pressure detection element 55 on the side toward the screw shaft 31 is fitted into the circular opening 41b3. A circular end surface of the cylindrical columnar end portion 55a constitutes a pressure detection surface 55a1.

The pressure detection surface 55a1 forms a single circular surface in cooperation with the bottom surface of the bottom portion 41b1 of the cylindrical cup portion 41b, and the pressure detection surface 55a1 is in close contact with the above-described exposed portion of the transmission member 45. As can be understood from above, the transmission member 45 is accommodated within a fixed cylindrical columnar closed space defined by the bottom surface of the bottom portion 41b1 of the cylindrical cup portion 41b, the inner cylindrical surface 41b2 of the cylindrical cup portion 41b, the circular surface 47a of the plate 47, and the pressure detection surface 55a1, and is in close contact with these surfaces.

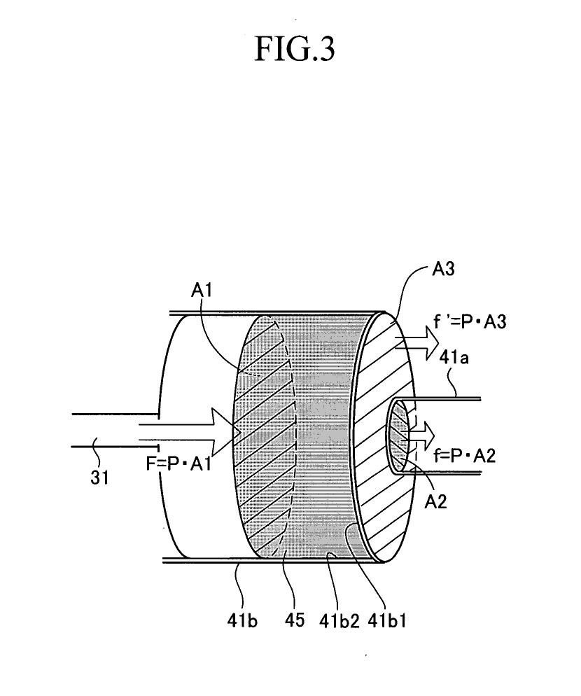

Operation of the pressure sensor S1 having the above-described structure will be described with reference to FIG. 3, which schematically shows the transmission member 45 and the vicinity thereof. When the transmission member 45 axially receives the above-described total load from the circular surface 47a of the plate 47, a pressure corresponding to the total load uniformly acts on the entire surface of the transmission member 45 accommodated in the closed space. Here, when the area of the circular surface 47a is represented by A1, the total load is represented by F, and the pressure is represented by P, a relation F=P−A1 stands.

The pressure P also uniformly acts on the exposed portion. Accordingly, the pressure detection surface 55a1 uniformly receives the pressure P. When the area of the exposed portion is represented by A2, the pressure detection surface 55a1 receives a load f=P−A2 (=F−(A2/A1)). Since a relation A2<A1 stands, the load f is a portion of the total load F, and assumes a value proportional to the total load F. In other words, the pressure sensor S1 detects the load f, which is a portion of the total load F, by detecting the pressure P. Notably, the load f is received by the axial load-receiving portion 21a of the housing 21 via the base portion 41a . Further, when the area of contact between the transmission member 45 and the bottom surface of the bottom portion 41b1 is represented by A3, a load f=P·A3 is received by the axial load-receiving portion 21a as in the case of the load f.

The load f is proportional to the total load F, and the total load F is proportional to the above-described cable tension, as described above. Accordingly, the electric control apparatus ECU can control the electric motor 11 on the basis of the load f detected by the pressure sensor S1 so as to control the cable tension.

As described above, the load detected by the pressure sensor S1 is a portion of the total load F; therefore, the pressure sensor S1 can be downsized as compared with the case where the pressure sensor S1 detects the total load F itself.

Next, operation of the motor-driven parking brake apparatus of the first embodiment having the above-described structure will be described. When a driver operates the brake switch SW1 (release switch SW2), the electric motor 11 is driven to rotate in the regular direction (reverse direction), whereby the screw shaft 31 of the conversion mechanism B is rotated in the regular direction (reverse direction). As a result, the equalizer mechanism C moves from the release position indicated by the solid line in FIG. 1 (brake position indicated by the two-dot chain line in FIG. 1) to the brake position (release position). Therefore, the inner wires 13a of the cables 13 are pulled (released), so that the parking brakes PB are brought into a braking state (release state).

The rotation of the electric motor 11 in the regular direction is sopped when the load f detected by the pressures sensor S1 reaches a predetermined first value. The rotation of the electric motor 11 in the reverse direction is stopped when the load f detected by the pressures sensor S1 reaches a predetermined second value (<the first value; approximately zero).

Incidentally, in the motor-driven parking brake apparatus according to the first embodiment of the present invention, when the parking brakes PB are in a braking state; i.e., when the above-described cable tension (>0) is generated, the axial load-receiving portion 21a of the housing 21 receives the axial load of the screw shaft 31 via the transmission member 45, and the cable reaction-receiving portions 21b of the housing 21 receive reactions from the cables 13 via the first ends 13b of the outer tubes.

Since the axial load-receiving portion 21a and the cable reaction-receiving portions 21b, which receive large loads, are located close to one another, securing of strength is easy, and these portions are not required to have an excessively large wall thickness. Further, the axial load and the reactions from the cables 13 do not act on the remaining portion of the housing 21, whereby the wall thickness of the remaining portion can be reduced.

That is, the axial load-receiving portion 21a and the paired cable reaction-receiving portions 21b (three portions) are disposed at one side (right side in FIG. 1) of the housing 21 to be located close to one another, and the axial load-receiving portion 21a is provided between the paired cable reaction-receiving portions 21b. Therefore, the size of the housing 21 can be reduced.

### Second Embodiment

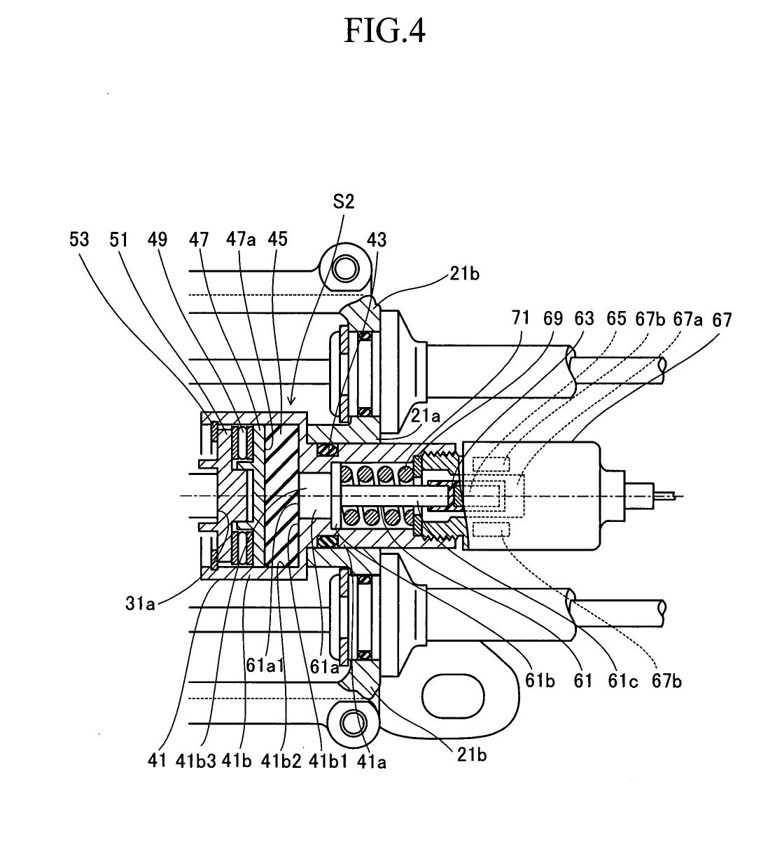

Next, a motor-driven parking brake apparatus according to a second embodiment of the present invention will be described. This second embodiment differs from the first embodiment only in the point that in place of the pressure sensor S1, a displacement sensor S2 is used as a load sensor for detecting the axial load of the screw shaft 31. Hereinbelow, only the point of difference will be described with reference to FIG. 4, which is an enlarged view of the displacement sensor S2. In FIG. 4, members and portions identical with or equivalent to those shown in FIG. 2 are denoted by like reference numerals, and their descriptions will not be repeated. For each of the axially movable members shown in FIG. 4, a corresponding axial position in a state shown in FIG. 4 (when the total load F is zero) is referred to as “original position.”

A spool 61 (movable member), which assumes the form of a stepped cylindrical tube and has a larger diameter portion 61a , a flange portion 61b, and a smaller diameter portion 61c , is accommodated in the cylindrical columnar interior space of the base portion 41a of the casing 41 of the displacement sensor S2 such that the spool 61 is coaxial with the screw shaft 31 and can move in the axial direction.

As in the case of the cylindrical columnar end portion 55a of the above-described pressure detection element 55, the larger diameter portion 61a is fitted into the circular opening 41b3. A cylindrical columnar magnet 65 is fixedly attached to a distal end portion of the smaller diameter portion 61c via a resin member 63 to be coaxial with the smaller diameter portion 61c (i.e., coaxial with the screw shaft 31).

A displacement detection element 67 electrically connected to the electric control unit ECU is screwed into an end portion of the base portion 41a opposite the screw shaft 31 via a spring retainer 69 to be coaxial with the screw shaft 31.

The magnet 65 extends into a cylindrical columnar interior space 67a formed in the displacement detection element 67 coaxially with the screw shaft 31. A plurality of Hall IC elements 67b are fixedly disposed within the displacement detection element 67 to face the cylindrical surface of the magnet 65 with a predetermined gap and surround the circumference of the magnet 65. With this arrangement, the displacement detection element 67 can detect the axial position of the magnet 65 (accordingly, the spool 61).

In the cylindrical columnar interior space of the base portion 41a , a coil spring 71 is disposed between the flange portion 61b of the spool 61 and the spring retainer 69 with the initial load (load when the spool 61 is located at the original position) being set to zero. A circular end surface 61a 1 of the larger diameter portion 61a (corresponding to the pressure detections surface 55a1 of the above-described pressure detection element 55) is in contact with the exposed portion of the transmission member 45.

Thus, when the total load F is zero, the axial position of the circular end surface 61a 1 coincides with the bottom surface of the bottom portion 41b1 of the cylindrical cup portion 41b (see FIG. 4).

Operation of the displacement sensor S2 having the above-described structure will be described with reference to FIG. 4 corresponding to FIG. 2. In the case of the second embodiment, unlike the above-described pressure detection surface 55a1, which cannot move in the axial direction, the circular end surface 61a 1 of the spool 61 can move rightward in FIG. 4 against the elastic force of the coil spring 71.

Accordingly, when the transmission member 45 axially receives the above-described total load F from the circular surface 47a of the plate 47, the exposed portion of the transmission member 45 deforms and projects into the circular opening 41b3 while pushing the spool 61 (the circular end surface 61a1 thereof rightward in FIG. 4. In other words, the spool 61 moves rightward in FIG. 4 from the original position over a distance corresponding to the amount of projection of the exposed portion into the circular opening 41b3 (hereinafter referred to as “projection amount”).

The projection amount tends to be proportional to the total load F. Therefore, the axial displacement of the spool 61 from the original position is proportional to the total load F. In other words, the displacement sensor S2 detects the above-described load f, which is a portion of the total load F, by detecting the axial displacement of the spool 61 from the original position. Accordingly, as in the case of the above-described pressure sensor S1, the electric control apparatus ECU can control the electric motor 11 on the basis of the load f detected by the displacement sensor S2 so as to control the cable tension.

As described above, the load detected by the displacement sensor S2 is also a portion of the total load F; therefore, the displacement sensor S2 can be downsized as compared with the case where the displacement sensor S2 detects the total load F itself.

In the above-described second embodiment, when an amount of rightward movement of the spool 61 from the original position in FIG. 4 is represented by δ, the projection volume of the exposed portion of the transmission member 45 is approximated by A2·δ, and the amount of rightward movement of the screw shaft 31 from the original position is approximated by A2·δ/A1, and is very small. That is, the ratio of increase in the movement amount of the screw shaft 31 to increase in the cable tension is small. Accordingly, rotation loss of the electric motor 11 associated with movement of the screw shaft 31 becomes very small, and the drive efficiency of the electric motor 11 becomes high. That is, cable moving loss of the inner wires 13a of the paired cables 13 produced upon movement of the screw shaft 31 becomes very small, and the operation efficiency of the apparatus becomes high.

What is claimed is:

1. A motor-driven parking brake apparatus comprising:
a housing;
an electric motor fixed to the housing;
a shaft member which rotates about its axis upon receipt of rotational drive torque of the motor through one end of the shaft member;
a conversion mechanism which converts rotational motion of the shaft member to translational motion of a translational movement portion;
a pair of cables having first ends connected to the translational movement portion; and
a pair of parking brakes connected to second ends of the cables,
wherein the housing includes a pair of reaction-receiving portions for receiving reactions from the cables generated due to tensions of the cables, and an axial load-receiving portion for receiving axial load from the other end of the shaft member, the load being generated due to the tensions of the cables, and
wherein the pair of reaction-receiving portions and the axial load-receiving portion are provided on one side of the housing, and the axial load-receiving portion is provided between the pair of reaction-receiving portions.

2. A motor-driven parking brake apparatus according to claim 1, wherein a load sensor for detecting axial load of the shaft member is provided between the axial load-receiving portion of the housing and the other end of the shaft member.

3. A motor-driven parking brake apparatus according to claim 2, wherein the load sensor is a pressure sensor which detects pressure generated due to the axial load of the shaft member.

4. A motor-driven parking brake apparatus according to claim 2, wherein the load sensor is a displacement sensor which includes a movable member which moves in accordance with the axial load of the shaft member and detects displacement of the movable member.
